(19) United States
(12) Patent Application Publication
(10) Pub. No.: US 2025/0328342 A1
(43) Pub. Date: Oct. 23, 2025

(54) DIVERGENT INFORMATION MAPPING SYSTEM

(71) Applicant: ELECTRONIC ARTS INC., Redwood City, CA (US)

(72) Inventor: Nikolaos Koufou, Port Moody (CA)

(21) Appl. No.: 18/638,489

(22) Filed: Apr. 17, 2024

(30) Foreign Application Priority Data
Apr. 17, 2024 (EP) 24386045.9

(51) Int. Cl. G06F 8/77; G06F 8/73

(52) U.S. Cl. CPC G06F 8/77; G06F 8/73

(57) ABSTRACT

Systems and methods are provided for implementing an improve mapping process to help identify disparate information associated with a software application in separately stored files. In this way, the information may remain separate and distinct, often times assigned to different teams, devices, and locations, and still be used to create a software application from the disparate information. For example, the system can generate a graph that comprises nodes that identify various information/functions from disparate data sources and edges that identify relationships between this information. Using the graph, the system may receive a query from a user device and generate a response to the query, where the graph can help narrow the search space in determining the response to the query.

### REFERENCE TO RELATED APPLICATION

The present application claims priority to European Patent Application No. *****, filed Apr. 17, 2024 and titled “DIVERGENT INFORMATION MAPPING SYSTEM,” which is incorporated herein by reference in its entirety.

### BACKGROUND

Large computer systems can process information separately and distinctly in order to create a software application from the distributed parts (e.g., software code files). Often times, the data and files that are used to create the software application is siloed with several versions of the distributed parts in existence and stored at individual user devices.

### SUMMARY

Systems and methods are presented for a mapping system that graphs relationships between various software code and other divergent/distributed information. In some examples, the method comprises generating and storing location metadata of a software code file in an augmented software code data store. The location metadata may be identified separately from contents of the software code file. The storage of the location metadata may be augmented with the contents of the software code file that are stored in the augmented software code data store. The method may also comprise determining a revision history of the software code file associated with a user identifier of the software code file. In some examples, the method may comprise storing the user identifier and the revision history of the software code file in the augmented software code data store. The user identifier and the revision history may be identified separately from the contents of the software code file. The storage of the user identifier and the revision history may be augmented with the contents of the software code file that are stored in the augmented software code data store. The method may also comprise automatically generating a graph that comprises nodes identifying at least a portion of the software code file, the user identifier, and the revision history and edges of the graph that identify relationships between the software code file, the user identifier, and the revision history. In some examples, using the graph, the method may generate a response to a query associated with a software application that is executed based on the software code file.

Technical improvements are described throughout the disclosure. For example, the system can use the graph to help narrow a search space in determining a response to a query from a user device. The communications between the system and data stores may be reduced because fewer queries may be submitted to search the data. Additionally, software development tools (e.g., an Integrated Development Environment (IDE), software code file editor, a compiler, a debugging processor/tool) can be improved. For example, the software development tool in communication with the system may receive a query from the user and access the graph associated with the query. The tool can match information from the software code file that the IDE is currently viewing to the graph associated with the software code file, for directed responses to the queries as they are being developed and within the context of the relevant software code file for the query.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a mapping system, user devices, data stores, and a communication network, in accordance with some examples of the disclosure.

FIG. 2 provides an illustrative process for data ingestion, augmentation, and query, in accordance with some examples of the disclosure.

FIG. 3 illustrates example data types and function definitions of the mapping system, in accordance with some examples of the disclosure.

FIG. 4 illustrates node and edge parameters of the mapping system, in accordance with some examples of the disclosure.

FIG. 5 illustrates node labels and edge types of the mapping system, in accordance with some examples of the disclosure.

FIG. 6 provides an illustrative relationship graph of nodes and edges, in accordance with some examples of the disclosure.

FIG. 7 provides an illustrative communication process between the user device and mapping system, in accordance with some examples of the disclosure.

FIG. 8 provides an illustrative user interface with a query and a response from a large language model (LLM), in accordance with some examples of the disclosure.

FIG. 9 provides an illustrative user interface with a query and a response from a large language model (LLM), in accordance with some examples of the disclosure.

FIG. 10 illustrates an example computing component that may be used to implement mapping in accordance with various embodiments.

FIG. 11 is an example computing component that may be used to implement various features of embodiments described in the present disclosure.

The figures are not exhaustive and do not limit the present disclosure to the precise form disclosed.

### DETAILED DESCRIPTION

Examples of systems and methods described herein can implement a mapping system and process to help identify the divergent/distributed parts of a software application in separately stored software code files. In this way, the information may remain separate and distinct, often times assigned to different teams, devices, and locations, and still be used to create a software application from the divergent/distributed parts. Additionally, the information may be distinct, divergent, and/or disparate where the data sources of the information are not configured to communicate with each other (absent a specialized system). The identification of the divergent/distributed parts in existence may help identify the appropriate software code to incorporate in the larger software program, and confirm that the correct software code is included with the software program.

The information used to create/compile/support the software application may comprise various formats and content stored that are originally stored in various locations. For example, information may be stored in version control repositories, wikis or other online publications that are collaboratively edited and managed, dynamic/static documents, Slack® channels, disk drives, or other data stores.

In an assessment of these potentially divergent/distinct types of data, the system may generate a graph (e.g., relationship graph). The graph may comprise nodes that identify various information that is distributed throughout the computing environment. In some examples, the nodes represent a function with a particular label that defines the node. The data associated with each node may be stored as a record/row in a relational database or other implementation type of the data store. The graph may also comprise edges that identify relationships between this information. The edges of the graph may be the field associated with the node/function, and the graphing engine may draw the line between the nodes and label corresponding to the edge field.

Using the graph, the system may generate a response to a query associated with a software application that is executed based on the software code file. In some examples, the mapping may also provide the data store as a searchable source of information for a large language model (LLM). In some examples, the information is provided to a pre-configured model and output from the model is received. In any of these examples, the system may receive a query from a user device and access the data store of mapped software code files. The system may populate the data store with previously-indexed, filtered, and stored data, which can help the pre-configured model determine a response to the query more efficiently.

In some examples, an Integrated Development Environment (IDE) or other software development tool can access the graph by matching information associated with the software code file that the IDE is currently viewing to the graph associated with the software code file. For example, the IDE may include a software code file editor, a compiler, a debugging processor/tool, or other features to review features of the software code files. An extension/API for the IDE can be implemented to facilitate the interaction with the system and find the appropriate graph(s). The information in the graph that is accessed by the extension/IDE can illustrate relationships between the files, locations, and user identifiers associated with the files. Using the extension/IDE, the user device may submit the query to the system, and the system can access the graph associated with the query, pull the information identified in the graph, construct the response, and provide the response/information to the user device. In this example, the user device, via the IDE, may access the information identified in the graph that is related to the software code file that the user is currently viewing via the IDE.

Some examples of the systems and methods described herein may comprise, for example, a system configured to receive a software code file. The software code file may be enabled to be compiled to generate a portion of a software application. In some examples, components of the software application are stored in distributed and separate software code data stores absent a central repository. The system may be configured to generate and store location metadata of the software code file in an augmented software code data store, determine a revision history of the software code file associated with a user identifier of the software code file, and store the user identifier and the revision history of the software code file in the augmented software code data store. The system may automatically generate a graph that comprises nodes that identify at least a portion of the software code file, the user identifier, and the revision history. The graph may also comprise edges that identify relationships between the software code file, the user identifier, and the revision history. Using the graph, the system may generate a response to a query associated with a software application that is executed based on the software code file.

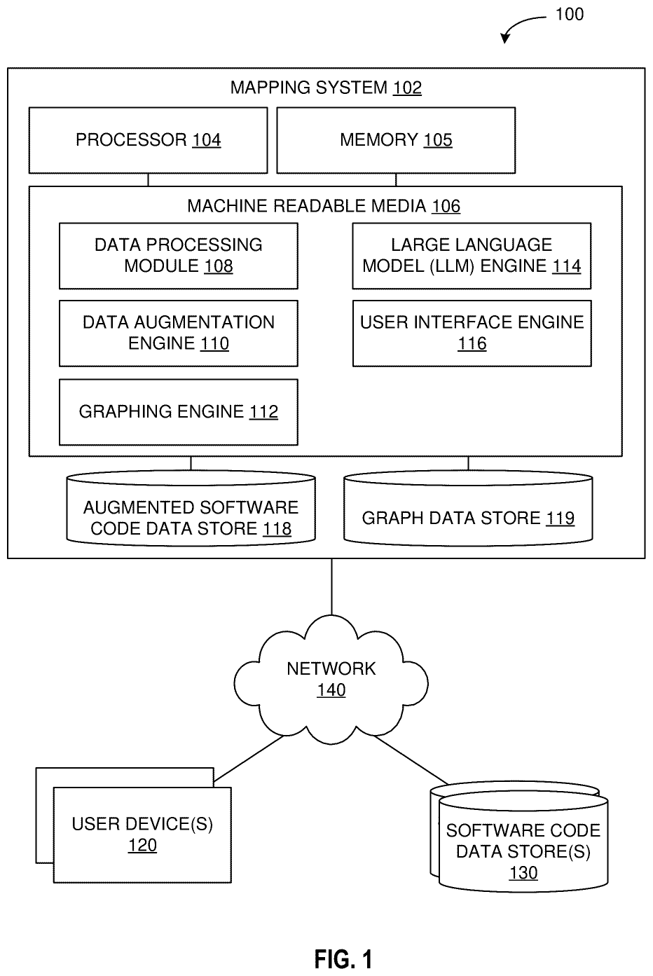

FIG. 1 illustrates a mapping system, user devices, distributed data stores, and a communication network, in accordance with some examples of the disclosure. In example 100, mapping system 102 is configured to map the sources/locations of code that have been distributed throughout a computing environment using processor 104 and memory 105. Mapping system 102 may be in communication with user devices 120 and software code data stores 130 via network 140.

Processor 104 may comprise a general-purpose or special-purpose processing engine such as, for example, a microprocessor, controller, or other control logic. Processor 104 may be connected to a bus, although any communication medium can be used to facilitate interaction with other components of mapping system 102 or to communicate externally.

Memory 105 may comprise random-access memory (RAM) or other dynamic memory for storing information and instructions to be executed by processor 104. Memory 105 might also be used for storing temporary variables or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, and modules for implementing the functionality discussed herein. Machine readable media 106 may carry one or more sequences of one or more instructions processor 104 for execution. Such instructions embodied on machine readable media 106 may enable identification and mapping of distributed software code across user devices 120, software code data stores 130, and other locations via network 140 to perform features or functions of the disclosed technology as discussed herein. For example, the interfaces, circuits, and modules of machine readable media 106 may comprise, for example, data processing engine 108, data augmentation engine 110, graphing engine 112, large language model (LLM) engine 114, and user interface engine 116.

Data processing engine 108 is configured to parse a query from a user. For example, the query may comprise classes, methods, users, or other information that is identifiable as corresponding with previously-stored nodes in graphs stored in graph data store 119. Data processing engine 108 may identify the subparts in the query that correspond with tokens or other previously-identified terms that correspond with nodes/edges in the graph, as described herein.

Data processing engine 108 is configured to receive a software code file. The software code file may be received through a push method or received through a pull method. In the push method, the data source may proactively transmit the software code file to data processing engine 108 via network 140. In the pull method, data processing engine 108 may receive a list of locations to monitor across the distributed computer system. The list of locations may include, for example, electronic addresses of servers, data stores, or other devices, online data stores (e.g., wikis), and the like. When a software code file is added or changed, the action may trigger data processing engine 108 to access the software code file and pull information from the file to a centralized location, like augmented software code data store 118. In some examples, the information from the file may be stored in a temporary storage location until contents of the file may be copied/stored in augmented software code data store 118.

Other examples of the pull method may be implemented as well. For example, data processing engine 108 may be configured to review information and continuously extract syntactic and/or semantic information from data stores, including software code data stores 130.

Data processing engine 108 is also configured to determine a revision history of the software code file associated with a user identifier of the software code file. For example, when the software code file is stored in data repository with revision control or versioning, data processing engine 108 may access the revision history of the identified file and implement the pull method to receive the revision history. In other examples, the revision control or versioning may not be available. In these instances, data processing engine 108 may access the file on a predetermined or periodic basis to receive contents of the file that are subsequently copied/stored to augmented software code data store 118 after each iteration/file access. The revision history may be stored in augmented software code data store 118.

Data processing engine 108 is also configured to determine the user identifier associated with the revision history of the software code file in augmented software code data store 118. For example, when the software code file is stored in data repository with revision control or versioning, data processing engine 108 may access the user identifier associated with the revision to receive the user identifier. In other examples, the revision control or versioning may not be available. In these instances, data processing engine 108 may access metadata of the file on a predetermined and periodic basis to receive contents of the file that are subsequently copied/stored to augmented software code data store 118 after each iteration/file access. The user identifier associated with each file access that creates changes in the file may be stored in augmented software code data store 118.

In some examples, data processing engine 108 is configured to receive a ticketing system file that describes an error associated with the software application. The ticketing system file may be received through a push method or received through a pull method with the ticketing system associated with mapping system 102. For example, when a new ticket is generated, the ticketing system may automatically transmit the ticketing system file to mapping system 102, or mapping system 102 may check periodically for updated tickets and pull the data. The graph may be automatically updated by graphing engine 112 with a node that identifies the ticketing system file and an edge of the graph that identifies a relationship between the ticketing system file, the error, where the nodes of the graph identify at least the portion of the software code file, the user identifier, and the revision history.

Data augmentation engine 110 is configured to generate and store location metadata of the software code file in augmented software code data store 118. For example, the location metadata may include an identifier of the data store or hierarchical folder location that stored the original data file (e.g., electronic addresses of servers, data stores, or other devices, online data stores (e.g., wikis), and the like).

Data augmentation engine 110 is also configured to classify the software code file. For example, the software code file may be classified to determine relationships between the contents of the file (e.g., payload, file location, metadata, etc.) and other files in the distributed environment. When the contents of the file are associated with a second file, data augmentation engine 110 may generate a data component that can link the contents of the two files. The identification of the contents of the file may be stored as nodes in graph data store 119 and the relationships between the nodes/file contents may be stored as edges in graph data store 119. In some examples, graph data store 119 may store syntax tree or semantic models (e.g., for performant querying of relationships between nodes/data types/functions). These data can be used to generate various graphs of the system by graphing engine 112.

In some examples, data augmentation engine 110 is configured to augment trees or machine learning models with supporting data. The data may be extracted from various sources and data stores, including static code analysis tools, runtime information/profilers, version control systems, issue trackers, knowledge repositories, chat support channels, forums, the web, and LLMs.

Graphing engine 112 is configured to automatically generate a graph that comprises nodes that identify at least a portion of the software code file, the user identifier, and the revision history. The nodes may each identify a class, method, or function, for example, of the software code files. As an illustrative example, the nodes in the graph may identify a top level workspace or a software application workspace, a software application file (e.g., action_graph.cs), an audit log file (e.g., with historical version control information), and any user identifiers that have accessed these files.

Graphing engine 112 is also configured to automatically generate a graph that comprises edges that identify relationships between the software code file, the user identifier, and the revision history. The edges may each identify a relationship between the nodes, including classes, methods, or functions.

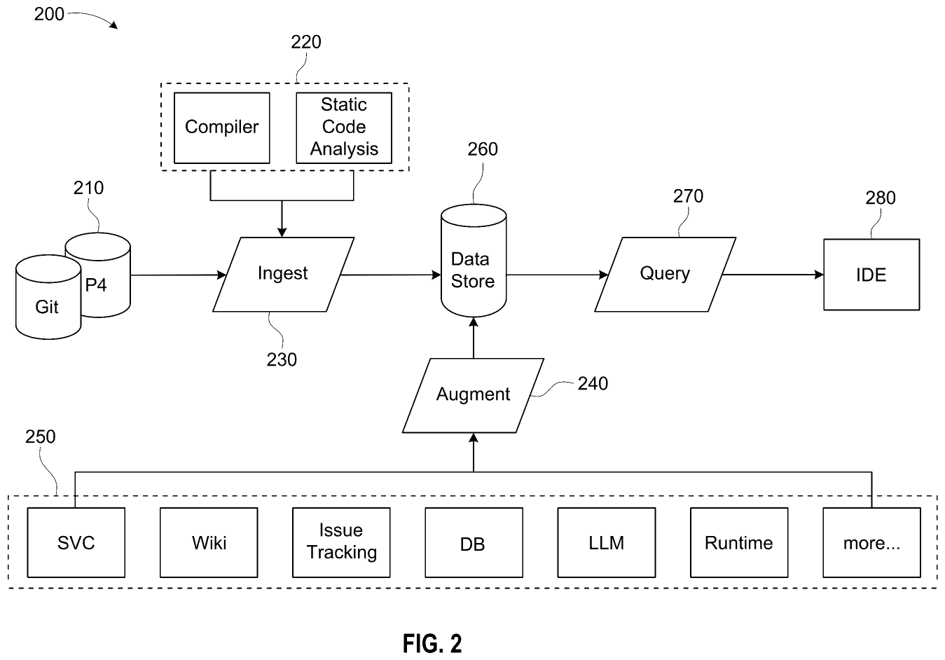

In some examples, graphing engine 112 may be configured to generate a graph structure. For example, graphing engine 112 may analyze the software code files to generate an intermediate format that captures the structure of the code (e.g., using the compiler or static code analysis tools illustrated in FIG. 2). These software code files (e.g., *.CS file or *.CPP files) may not correspond with an inherent structure and graphing engine 112 can create an abstract syntax tree to illustrate the structure of the software application (with corresponding software code files). The structure may be used as a baseline for adding nodes/edges to the overall graph.

In some examples, graphing engine 112 may be implemented as a machine learning model, LLM, or other model that is trained to classify the information. For example, the model may identify relationships between the nodes or augment/supplement information that is provided by data sources. In some examples, the relationships are determined, using the model, to extract semantic information from a piece of text which can then be used as an input into the process. The model may also be configured to generate embeddings, which can incorporated with the classification process. Graphing engine 112 may generate the embeddings by identifying nodes in the graph that can be semantically similar to augment or expand the nodes/edges in the graph.

Graphing engine 112 is also configured to automatically generate various types of graphs. For example, graphing engine 112 may generate a node graph where a node is identified in substantially the center of the graph and all the associations/edges from the node are generated from the central point/node. The node graph may comprise information associated with the nodes of the graph. In another example, graphing engine 112 may generate a relationship graph where several nodes/edges within a grouping are provided, absent a central point/node. The relationship graph may comprise information as the edges to describe the relationships between the nodes of the graph.

Large language model (LLM) engine 114 is configured to access a pre-configured model. With the pre-configured model, the training of the model may be implemented in an external system that is remote from LLM engine 114. LLM engine 114 may access the pre-configured model as a closed system, via an application programming interface (API) incorporated with the external system and network 140, to provide input to the pre-configured model. The pre-configured model may generate and provide the output to the LLM engine 114 via network 140.

In some examples, LLM engine 114 is configured to generate a response to a query by converting a natural language prompt (e.g., the query from user device 120) into a graph database query (e.g., using the graph generated by graphing engine 112). The query may be executed against graph data store 119 to access information identified in the graph and graph data store 119, and the results may be summarized and provided back to user device 120.

In some examples, LLM engine 114 may be trained to generate the response and a confidence score by applying the plurality of data (e.g., the software code files) as input to the LLM, such that the LLM is configured to generate the response and confidence score.

In some illustrative examples, LLM engine 114 may train the LLM to enable the LLM to generate the response and the confidence score. The training process may first preprocess the software code files. The preprocessing may include a data formatting process, where the software code files are converted from different software code file types (e.g., image format, Word® format, etc.) into a unified digital format (e.g., PDF file). The preprocessing may also include data extraction to help segment the contents of the software code file that may be irrelevant. The data extraction may discard/extract information, for example using optical character recognition (OCR) and natural language processing (NLP) techniques.

The training process may implement feature extraction on software code files, including data from the payload, file contents, or metadata. For example, once the preprocessing of the software code files is initiated, the input may be broken down into smaller units or tokens during a tokenization process. These tokens could be words, subwords, or characters, depending on the tokenization scheme used by the model. The feature extraction may also include an embedding lookup process, where embeddings are generated as high-dimensional vector representations of the tokens. These embeddings may correspond with semantic and syntactic properties of the tokens and mathematical relationships between the tokens.

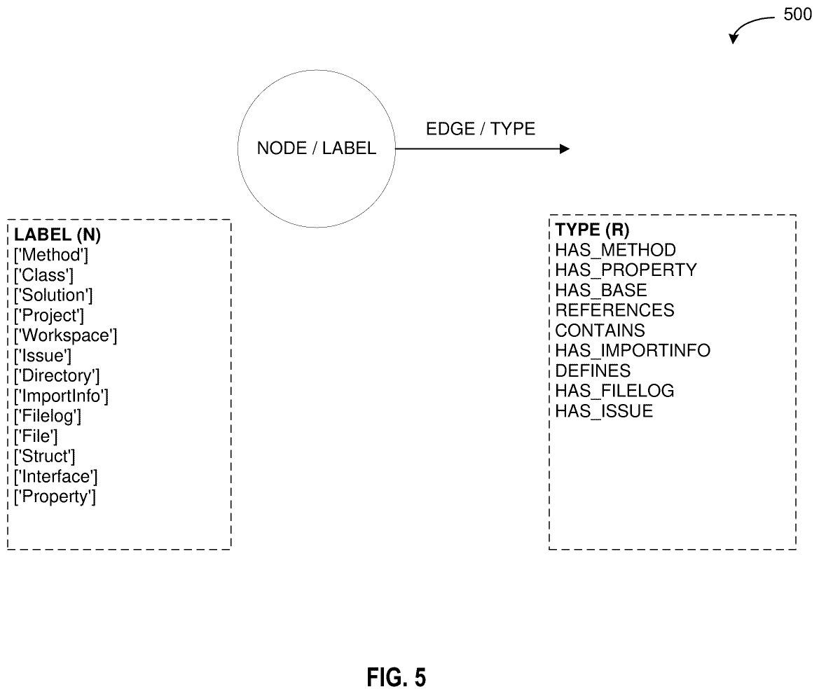

Illustrative relationships between the data may include various classes and methods that reference each other or related entities in the software code files, for example, HAS_METHOD, HAS_PROPERTY, HAS_BASE, REFERENCES, CONTAINS, DEFINES, HAS_FILELOG, HAS_ISSUE, HAS_METHOD, HAS_PROPERTY, HAS_BASE, HAS_IMPORTINFO, HAS_DIVERGENCE, or any other relevant information present in the plurality of data. These relationships may be identified as the edge or type in the graph illustrated in FIG. 5. For example, the HAS_METHOD class or method in a software code file may be accessed by a particular user. The software code file may be identified as a first node and the user that accesses/utilizes the class or method may be identified as the second node, with an edge labeled HAS_METHOD between the two nodes in the graph. In some examples, the determined relationships between the tokens may be used as descriptions associated with edges in the graph between the nodes.

In some examples, the feature extraction process may encode the embeddings for the individual tokens using transformers or recurrent neural networks. In some examples, the encoding process can generate contextualized representations for each token by identifying and incorporating its surrounding context within the input data (e.g., the software code files). Using these encodings, the feature extraction process may extract relevant features from the encoded representations by transforming the encoded representations into feature vectors. In some examples, the feature extraction process may reduce the dimensionality of the extracted features using a dimensionality reduction technique (e.g., principal component analysis (PCA) or t-distributed stochastic neighbor embedding (t-SNE), etc.).

In some examples, the feature extraction process may normalize or scale the feature vectors (e.g., z-score normalization or min-max scaling, etc.) to create consistent ranges and distributions for the extracted features. When normalization is incorporated with the feature extraction process, normalization can help prevent features with large magnitudes from dominating the learning process and ensure that the model can effectively learn from the input data (e.g., the software code files).

In some examples, the feature extraction process may implement feature selection (e.g., technique like filtering or wrapper methods), remove discard irrelevant or redundant features, and generate an output. The output of the feature selection process may be used as input to downstream tasks, such as classification, regression, sequence generation, or generating output text for the model based on the learned patterns and relationships in the input data (e.g., the software code files). As illustrative examples, the training may comprise a cross-entropy loss to classify the nodes and the edges, and a mean squared error for regression tasks.

LLM engine 114 is also configured to generate a confidence score with the response. Various processes may be implemented to generate the confidence score associated with the response, including a Naive Bayes classifier, logistic regression, neural network based structured prediction, or natural language understanding. In some examples, a set of responses are generated and the response with the highest confidence score may be provided to the user interface via user interface engine 116.

User interface engine 116 is configured to provide the graph and response that is generated by LLM engine 114 to a user interface of user device 120. For example, user interface engine 116 may comprise a rendering engine that can utilize a graphics library and/or APIs (such as OpenGL, DirectX, or Vulkan) to render the query and the response to display both at user device 120.

Augmented software code data store 118 may comprise information associated with the software code file, including the payload, file location, metadata, and any generated or augmented information, including the location metadata, user identifier, the revision history of the software code file, or other information discussed herein.

Graph data store 119 may comprise nodes and edges of the relationship graph or other graphs generated by graphing engine 112. For example, the identification of contents of the software code file may be stored as nodes in graph data store 119 and the relationships between the nodes/file contents may be stored as edges in graph data store 119.

In some examples, the nodes represent a function with a particular label that defines the node. The data associated with each node may be stored as a record/row in a relational database or other implementation type of the data store. The edges of the graph may be the field associated with the node/function, and the graphing engine may draw the line between the nodes and label corresponding to the edge field.

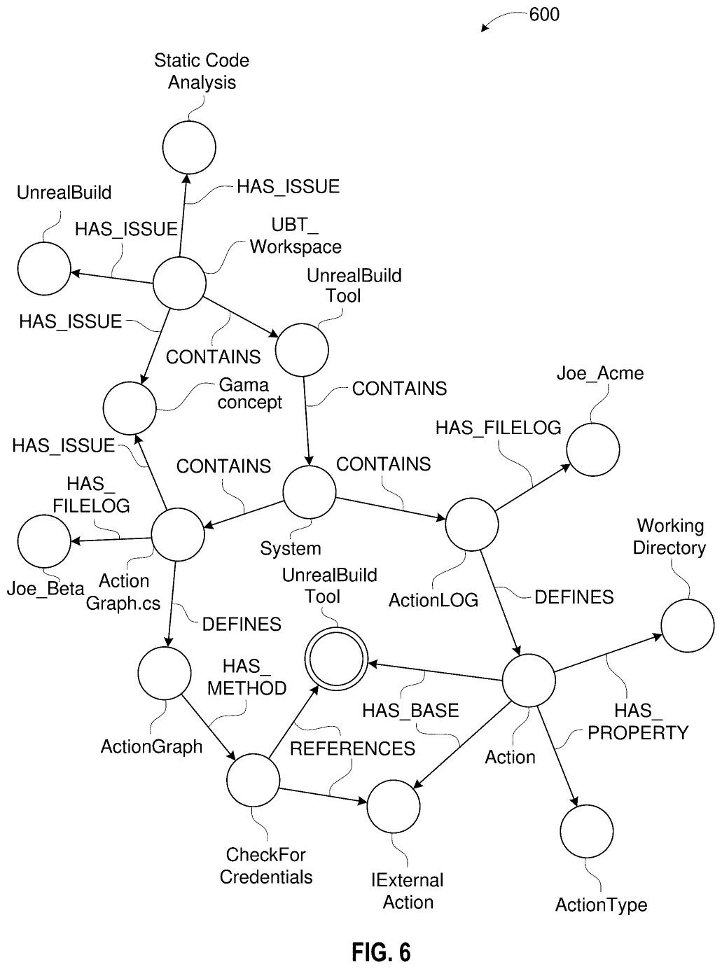

User device 120 is configured to generate and transmit a query to mapping system 102. User device 120 is also configured to display a response from mapping system 102, including a response to the query or graph associated with data components that may be accessed to generate the response to the query. Illustrative examples of the query and response, as well as an illustrative graph, are provided with FIGS. 6-8.

Software code data store 130 may correspond with a set of locations and devices that store software code files. The software code files may be enabled to be compiled to generate a portion of a software application, or they may correspond with previously compiled software code that is now stored at each software code data store 130. In some examples, components of the software application that are stored in each software code data store 130 are located in distributed and separate software code data stores absent a central repository.

FIG. 2 provides an illustrative process for data ingestion, augmentation, and query, in accordance with some examples of the disclosure. In example 200, the illustrative process may be performed by devices described throughout the application, including mapping system 102 in FIG. 1.

At block 210, data stores are illustrated that can be used to store various types of software code files. Illustrative data stores may comprise, for example, Git® or P4®, although any data store is available without diverting from the essence of the disclosure, including servers, cache/SSD data stores, or other devices, online data stores (e.g., wikis), and the like. In some examples, the data store can manage, track, and control changes to the software code files in addition to storing the files.

At block 220, the syntactic and semantic information may be extracted from the software code files. For example, application tools like a compiler or static code analysis tools, may analyze the files and determine the syntactic and semantic information.

In some examples, the compiler or static code analysis tools may implement feature extraction on software code files, including data from the payload, file contents, or metadata. For example, once the preprocessing of the software code files is initiated, the input may be broken down into smaller units or tokens during a tokenization process. These tokens could be words, subwords, or characters, depending on the tokenization scheme used by the model. The compiler or static code analysis tools may also include an embedding lookup process, where embeddings are generated as high-dimensional vector representations of the tokens. These embeddings may correspond with semantic and syntactic properties of the tokens and mathematical relationships between the tokens.

In some examples, data augmentation engine 110 in FIG. 1 may implement an embedding lookup process rather than the compiler or static code analysis tools. In this example, data processing engine 108 in FIG. 1 may invoke the compiler or static code analysis tools to generate structure definition files that are provided back into the system (e.g., in the format of an XML file or other data structure definition). Data augmentation engine 110 may provide the structure definition files to an LLM or other pre-configured model in order to generate the embeddings (as discussed with LLM engine 114 in FIG. 1). In this example, at block 230, an ingestion process may generate the graph by reading the generated output from compiler and, at block 240, the augmentation process may use the pre-configured model to generate any embeddings.

Once features are extracted, embeddings may be created and stored with the software code files. In some examples, the embeddings and other features of the graph that are generated by the compiler or static code analysis tools can help improve the query/response lookup process at block 270. For example, the embeddings can help narrow the search space in determining a response to a query from a user device.

In some examples, the system processes the software code files to generate an intermediate format that captures the structure of the code (e.g., using the compiler or static code analysis tools). For example, several software code files (e.g., *.CS file or *.CPP files) may not correspond with an inherent structure. The system can create an abstract syntax tree to illustrate the structure of the software application (with corresponding software code files) and ingest the structure of the code when generating the graph. The system may use the structure as a baseline for adding nodes/edges.

In other examples, a static code analysis tool may be implemented to extract metadata from a file or other data source. The static code analysis tool can help ensure that the code adheres to industry standards by determining whether the file includes programming errors, coding standard violations, undefined values, syntax violations, or security vulnerabilities.

At block 230, the process may ingest the data. For example, the process may receive a software code file from any of the set of data stores illustrated in block 210 and block 220 using a push method or a pull method. In the push method, the data source may proactively transmit the software code file to the system. In the pull method, the system may receive a list of locations to monitor across the distributed computer system and access those locations for the software code file. When a software code file is added or changed, the action may trigger the system to access the software code file and pull information from the file to a centralized location.

At block 240, the process may initiate an augmentation process. For example, augmentation process may access various data stores and supplement data that has been stored during the ingestion process (e.g., metadata and embeddings, etc.). For example, the augmentation may generate and store location metadata of the software code file, an identifier of the data store or hierarchical folder location that stored the original data file (e.g., electronic addresses of servers, data stores, or other devices, online data stores (e.g., wikis), and the like),

In some examples, the augmentation process may classify the data to help determine relationships between the contents of the file (e.g., payload, file location, metadata, etc.) and other files in the distributed environment. When the contents of the file are associated with a second file, the augmentation process may generate a data component that can link the contents of the two files.

At block 250, various sources of data augmentation are illustrated and may be accessed by the system during the augmentation process. For example, the data sources may comprise a Storage Area Network (SAN) Volume Controller (SVC), wiki or other online publications that are collaboratively edited and managed, issue tracking tool, database or data store (DB), LLM, runtime, and other data sources.

In some examples, these data sources may store divergent data. The data sources may not be configured to communicate via a network with each other or share the divergent data with each other. In some examples, the format of each data source may correspond with a file structure/format that is incompatible with the other data sources, so that information is not easily shared between the data sources.

At block 260, the process may populate the data generated from the ingestion process and the data generated from the augmentation process and store the combined data in a data store, like augmented software code data store 118 or graph data store 119 in FIG. 1.

At block 270, the process may provide the data in a graph. The graph may comprise nodes that identify various information, including the information identified at block 210 or additional information generated at block 220. The nodes in the graph may represent a function with a particular label that defines the node and the edges in the graph may identify relationships between this information.

At block 280, the graph may be provided to an IDE or other software development tool that receives a query from a user device. The IDE or other tool can access the graph by matching information associated with the software code file that the IDE is currently viewing to the graph associated with the software code file. For example, the IDE may include a software code file editor, a compiler, a debugging processor/tool, or other features to review features of the software code files.

In some examples, an extension/API for the IDE can be implemented to facilitate the interaction with the system and find the appropriate graph(s). The information in the graph that is accessed by the extension/IDE can illustrate relationships between the files, locations, and user identifiers associated with the files. Using the extension/IDE, the user device may submit the query to the system, and the system can access the graph associated with the query, pull the information identified in the graph, construct the response, and provide the response/information to the user device. In this example, the user device, via the IDE, may access the information identified in the graph that is related to the software code file that the user is currently viewing via the IDE.

In some examples, the query may be matched to the graph with a node that corresponds with the greatest confidence score correlation to the query. In other examples, the pre-configured model may generate a second query in response to receiving a first query from a user when the confidence score associated with the potential responses fail to exceed a threshold value. The second query may be generated to determine more relevant nodes/edges from the graph to provide a more relevant response to the first query.

In some examples, multiple iterations of responses may be generated until the confidence value associated with the response exceeds a threshold value. For example, the first response may correspond with a first confidence value less than the threshold value. The pre-configured model can provide additional information for a second query, including filtering by a user identifier, location metadata, revision history, or other information that may be referenced in the first query or associated with the user that is submitting the query. A second response may be generated based on the filtered data incorporated with the second query.

In some examples, the query process may implement a Retrieval-Augmented Generation (RAG) process that accesses the training data and other data sources discussed throughout the disclosure to help optimize the response generation to the query from the user device. In some examples, the authoritative database that the RAG process can identify with a greater confidence is augmented software code data store 118 illustrated in FIG. 1.

In some examples, the response to the query may comprise information about the software code files or distributed software application environment to help illustrate the relationships between the files, locations, and user identifiers associated with the files. In some examples, the IDE may include a software code file editor, a compiler, a debugging processor/tool, or other features to review features of the software code files.

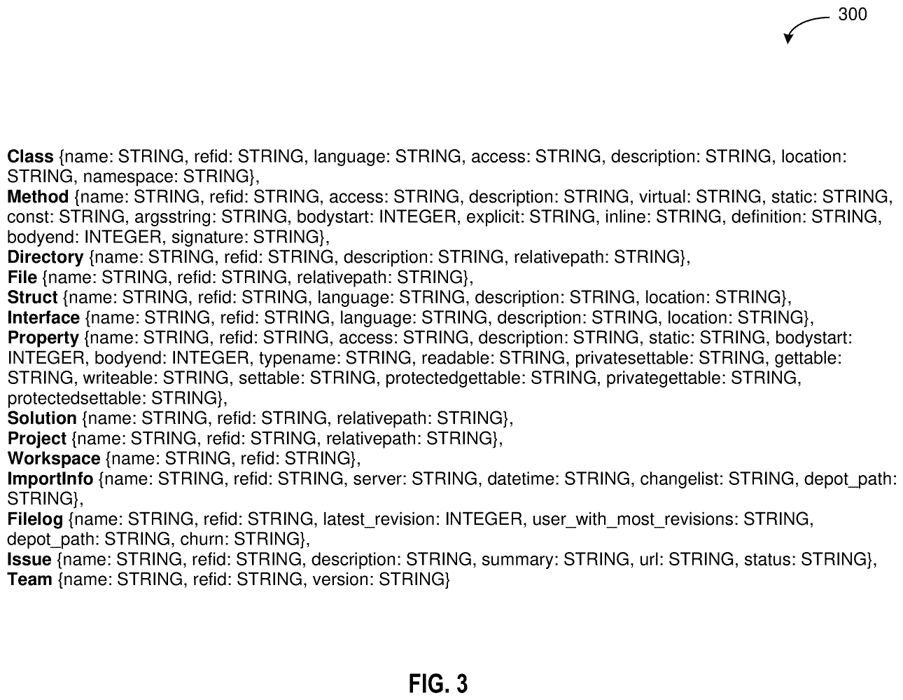

FIG. 3 illustrates example data types and function definitions of the mapping system, in accordance with some examples of the disclosure. In example 300, various data types and functions are illustrated that may help define components of the software code files. Information associated with the data types and function may be used to generate nodes and edges that define relationships between components of the distributed software code files. Various examples are provided herein to help illustrate the components of the system and should not be limiting to the essence of the disclosure.

The “class” function may comprise several data types, including a “name” field as a STRING data type, a “refid” field as a STRING data type, a “language” field as a STRING data type, an “access” field as a STRING data type, a “description” field as a STRING data type, a “location” field as a STRING data type, and a “namespace” field as a STRING data type.

The “method” function may comprise several data types, including a “name” field as a STRING data type, a “refid” field as a STRING data type, an “access” field as a STRING data type, a “description” field as a STRING data type, a “virtual” field as a STRING data type, a “static” field as a STRING data type, a “const” field as a STRING data type, an “argsstring” field as a STRING data type, a “bodystart” field as a INTEGER data type, an “explicit” field as a STRING data type, an “inline” field as a STRING data type, a “definition” field as a STRING data type, a “bodyend” field as a INTEGER data type, and a “signature” field as a STRING data type.

The “directory” function may comprise several data types, including a “name” field as a STRING data type, a “refid” field as a STRING data type, a “description” field as a STRING data type, and a “relativepath” field as a STRING data type.

The “file” function may comprise several data types, including a “name” field as a STRING data type, a “refid” field as a STRING data type, and a “relativepath” field as a STRING data type.

The “struct” function may comprise several data types, including a “name” field as a STRING data type, a “refid” field as a STRING data type, a “language” field as a STRING data type, a “description” field as a STRING data type, and a “location” field as a STRING data type.

The “interface” function may comprise several data types, including a “name” field as a STRING data type, a “refid” field as a STRING data type, a “language” field as a STRING data type, a “description” field as a STRING data type, and a “location” field as a STRING data type.

The “property” function may comprise several data types, including a “name” field as a STRING data type, a “refid” field as a STRING data type, an “access” field as a STRING data type, a “static” field as a STRING data type, a “bodystart” field as a INTEGER data type, a “bodyend” field as a INTEGER data type, a “typename” field as a STRING data type, a “readable” field as a STRING data type, a “privatesettable” field as a STRING data type, a “gettable” field as a STRING data type, a “writeable” field as a STRING data type, a “settable” field as a STRING data type, a “protectedgettable” field as a STRING data type, a “privategettable” field as a STRING data type, and a “protectedsettable” field as a STRING data type.

The “solution” function may comprise several data types, including a “name” field as a STRING data type, a “refid” field as a STRING data type, and a “relativepath” field as a STRING data type.

The “project” function may comprise several data types, including a “name” field as a STRING data type, a “refid” field as a STRING data type, and a “relativepath” field as a STRING data type.

The “workspace” function may comprise several data types, including a “name” field as a STRING data type, and a “refid” field as a STRING data type.

The “ImportInfo” function may comprise several data types, including a “name” field as a STRING data type, a “refid” field as a STRING data type, a “server” field as a STRING data type, a “datetime” field as a STRING data type, a “changelist” field as a STRING data type, and a “depot_path” field as a STRING data type.

The “filelog” function may comprise several data types, including a “name” field as a STRING data type, a “refid” field as a STRING data type, a “latest_revision” field as a STRING data type, a “user_with_most_revisions” field as a STRING data type, a “depot_path” field as a STRING data type, and a “churn” field as a STRING data type.

The “issue” function may comprise several data types, including a “name” field as a STRING data type, a “refid” field as a STRING data type, a “description” field as a STRING data type, a “summary” field as a STRING data type, a “URL” field as a STRING data type, and a “status” field as a STRING data type.

The “team” function may comprise several data types, including a “name” field as a STRING data type, a “refid” field as a STRING data type, and a “version” field as a STRING data type.

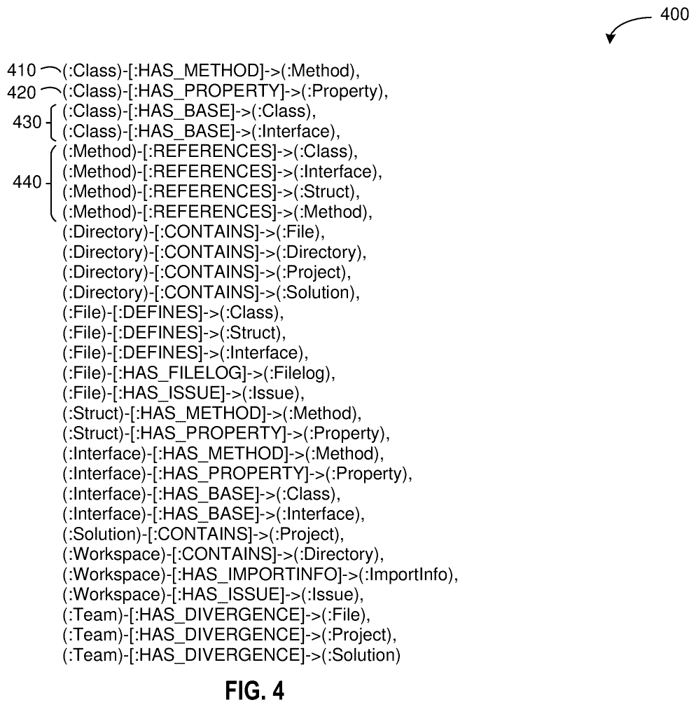

FIG. 4 illustrates node and edge parameters of the mapping system, in accordance with some examples of the disclosure. In example 400, the options for associating the functions and data types is shown.

At block 410, a “class” function may be associated with a “method” function. The relationship between the “class” function and the “method” function may be identified in the “HAS_METHOD” field. The “HAS_METHOD” field can be identified as an edge between the two functions in a graph.

At block 420, a “class” function may be associated with a “property” function. The relationship between the “class” function and the “property” function may be identified in the “HAS_PROPERTY” field. The “HAS_ PROPERTY” field can be identified as an edge between the two functions in a graph.

At block 430, a “class” function may be associated with another “class” function or an “interface” function. The relationship between the “class” function and the “class” function, or between the “class” function and the “interface” function may be identified in the “HAS_BASE” field. The “HAS_ BASE” field can be identified as an edge between either of the two functions in a graph.

At block 440, a “method” function may be associated with any of the functions labeled “class,” “interface,” “struct,” or “method.” The relationship between the “method” function and the “class” function, or between the “method” function and the “interface” function, or between the “method” function and the “struct” function, or between the “method” function and the “method” function may be identified in the “REFERENCES” field. The “REFERENCES” field can be identified as an edge between any of the related functions in a graph.

In example 400, other relationship associations are provided for illustrative purposes and are similar to the examples described herein.

FIG. 5 illustrates node labels and edge types of the mapping system, in accordance with some examples of the disclosure. In example 500, the functions provided in example 400 of FIG. 4 may be used as labels for the nodes in a graph, and the fields provided in example 400 of FIG. 4 may be used as types of edges associated with each node in a graph.

Various examples are provided herein to help illustrate the components of the system and should not be limiting to the essence of the disclosure. The functions/labels that may be used as nodes in the graph may comprise, for example, method, class, solution, project, workspace, issue, directory, ImportInfo, filelog, file, struct, interface, and property functions/labels. The type/field that may be used as edges in the graph may comprise, for example, HAS_METHOD, HAS_PROPERTY, HAS_BASE, REFERENCES, CONTAINS, HAS_IMPORTINFO, DEFINES, HAS_FILELOG, and HAS_ISSUE type/field.

FIG. 6 provides an illustrative relationship graph of nodes and edges, in accordance with some examples of the disclosure. In example 600, an illustrative graph is provided. The graph may be generated to allow the data to be linked together directly. In some examples, the nodes represent a function with a particular label that defines the node. The data associated with each node may be stored as a record/row in a relational database or other implementation type of the data store (e.g., graph data store 119 in FIG. 1). The edges of the graph may be the field associated with the node/function, and the graphing engine may draw the line between the nodes and label corresponding to the edge field.

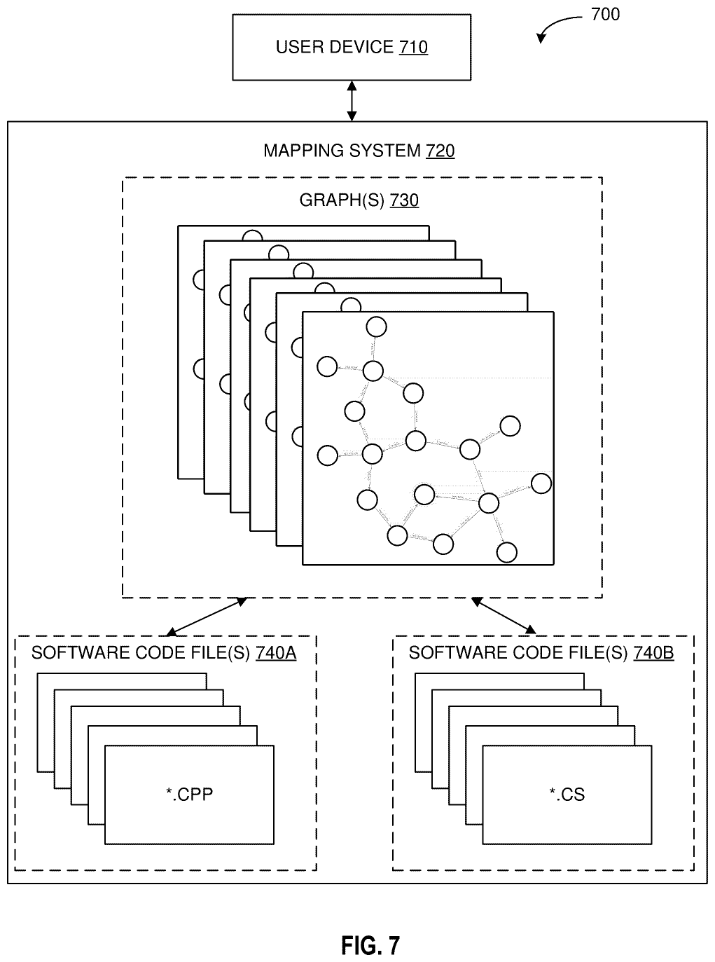

FIG. 7 provides an illustrative communication process between the user device and distributed code mapping system, in accordance with some examples of the disclosure. In example 700, a query/response process is illustrated between user devices 710 and mapping system 720. mapping system 720 may comprise graphs 730 and software code files 740, illustrated as first software code files 740A and second software code files 740B. In some examples, user devices 710 and mapping system 720 in FIG. 7 may correspond with user devices 120 and mapping system 102 in FIG. 1, respectively.

As an illustrative example, user devices 710 may implement an IDE to generate software code files associated with a software application (e.g., a game application). The user may activate a tool in the IDE to submit a query to mapping system 720. By activating the tool, user device 710 and mapping system 720 may establish a communication connection at least for a particular duration to receive the query at mapping system 720 from user device 710.

Mapping system 720 may receive information from the IDE/user device 710, including information about the software code file that the user is viewing with the IDE (e.g., software code file editor, a compiler, a debugging processor, etc.) and the contents of the query. Mapping system 720 may parse the query and other information provided by the IDE/user device 710 to match the information with a relevant graph 730. The graph may be stored in a graph database, like graph data store 119 illustrated in FIG. 1 and data store 260 in FIG. 2.

In some examples, graph 730 is generated prior to receiving the query from user device 710 and can illustrate relationships between the files, locations, and user identifiers associated with the files as nodes/edges in the graph. When a particular graph 730 is selected, software code file 740 associated with graph 730 can be accessed in order to generate the response to the query. For example, first software code file 740A may be accessed to pull the information identified in the graph, construct the response, and provide the response/information to user device 710 via IDE. Mapping system 720 may generate an explanation of the response/information (e.g., using an LLM or other pre-configured model).

In some examples, the process may be iterative to sequentially provide a query and response, then a second query, and so on. In this example, the user device 710 may be operating through prompt engineering to identify relevant information through a sequential series of queries. The information returned in each response may be used to further narrow the subsequent response in view of the subsequent query received by the system.

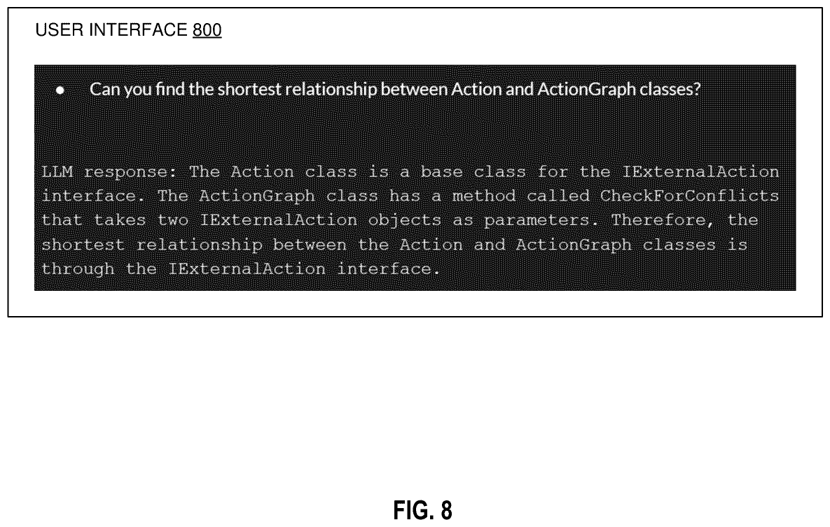

FIG. 8 provides an illustrative user interface with a query and a response from a large language model (LLM), in accordance with some examples of the disclosure. In user interface 800, an illustrative query and response are provided. The response to the query may be generated using the graph and LLM. The query/response may be associated with a software application that is executed based on the software code file.

For example, the query may recite “can you find the shortest relationship between Action and ActionGraph classes?” The graph and LLM, and corresponding data associations, may define the classes that are labeled “Action” and “ActionGraph” in the graphing data store. These classes may correspond with nodes in the graph, along with any relationships between the classes, which is also shown in the graph. Using the information, the LLM may determine the shortest path/relationship includes “IExternalAction” and generate the response to the query. For example, the response may recite “The Action class is a base class for the IExternalAction interface. The ActionGraph class has a method called CheckForConflicts that takes two IExternalAction objects as parameters. Therefore, the shortest relationship between the Action and ActionGraph classes is through the IExternalAction interface.”

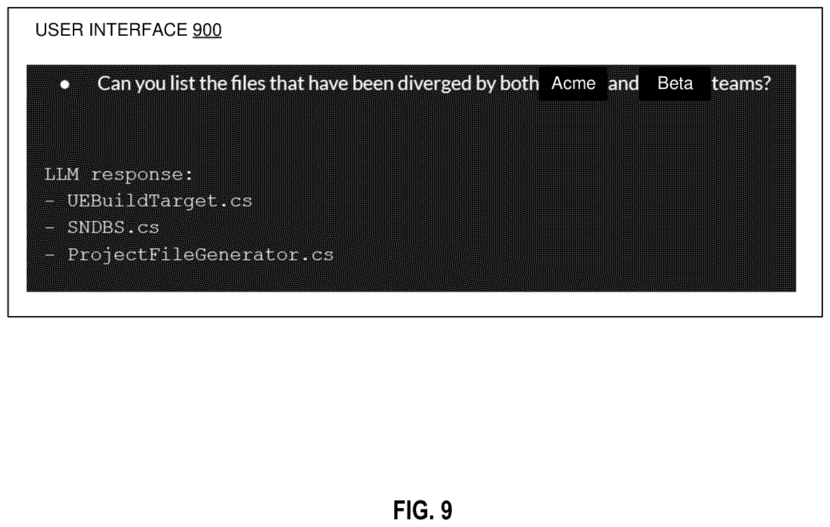

FIG. 9 provides an illustrative user interface with a query and a response from a large language model (LLM), in accordance with some examples of the disclosure. In user interface 900, an illustrative query and response are provided. The response to the query may be generated using the graph and LLM. The query/response may be associated with a software application that is executed based on the software code file.

For example, the query may recite “Can you list the files that have been diverged by both Acme and Beta teams?” The graph and LLM, and corresponding data associations, may define the classes as groups/teams that are labeled “Acme” and “Beta” in the graphing data store. These classes may correspond with nodes in the graph, along with any relationships between the classes, which is also shown in the graph. Using the information, the LLM may determine the files that have been diverged/updated by both teams from the revision history for each of the files. For example, the response may recite “UEBuildTarget.cs, SNDBS.cs, and ProjectFileGenerator.cs.”

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

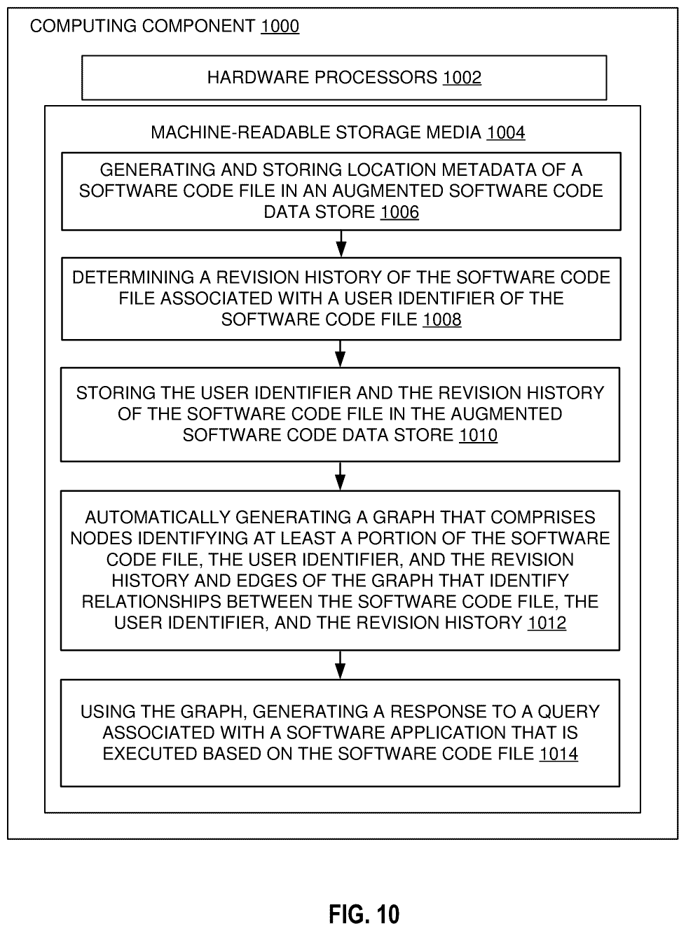

FIG. 10 illustrates an example computing component that may be used to implement distributed software code mapping in accordance with various embodiments. Computing component 1000 may be, for example, a server computer, a controller, or any other similar computing component capable of processing data. In the example implementation of FIG. 10, computing component 1000 includes hardware processors 1002, and machine-readable storage medium 1004.

Hardware processors 1002 may be one or more central processing units (CPUs), semiconductor-based microprocessors, and/or other hardware devices suitable for retrieval and execution of instructions stored in machine-readable storage medium 1004. Hardware processors 1002 may fetch, decode, and execute instructions, such as instructions 1006-1014, to control processes or operations for distributed software code mapping. As an alternative or in addition to retrieving and executing instructions, hardware processors 1002 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1004, may be any electronic, magnetic, optical, or other physical storage device that contains or stores executable instructions. Thus, machine-readable storage medium 1004 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 1004 may be a non-transitory storage medium, where the term “non-transitory” does not encompass transitory propagating signals. As described in detail below, machine-readable storage medium 1004 may be encoded with executable instructions, for example, instructions 1006-1014.

Hardware processors 1002 may execute instruction 1006 to generate and store location metadata of a software code file in an augmented software code data store. For example, the location metadata may be identified separately from contents of the software code file. The storage of the location metadata may be augmented with the contents of the software code file that are stored in the augmented software code data store.

Hardware processors 1002 may execute instruction 1008 to determine a revision history of the software code file associated with a user identifier of the software code file.

Hardware processors 1002 may execute instruction 1010 store the user identifier and revision history of the software code file in the augmented software code data store. For example, the user identifier and the revision history may be identified separately from the contents of the software code file. The storage of the user identifier and the revision history may be augmented with the contents of the software code file that are stored in the augmented software code data store.

Hardware processors 1002 may execute instruction 1012 automatically generate a graph that comprises nodes identifying at least a portion of the software code file, the user identifier, and the revision history and edges of the graph that identify relationships between the software code file, the user identifier, and the revision history.

Hardware processors 1002 may execute instruction 1014 to generate a response to a query associated with a software application that is executed based on the software code file. The response may be generated based on the graph.

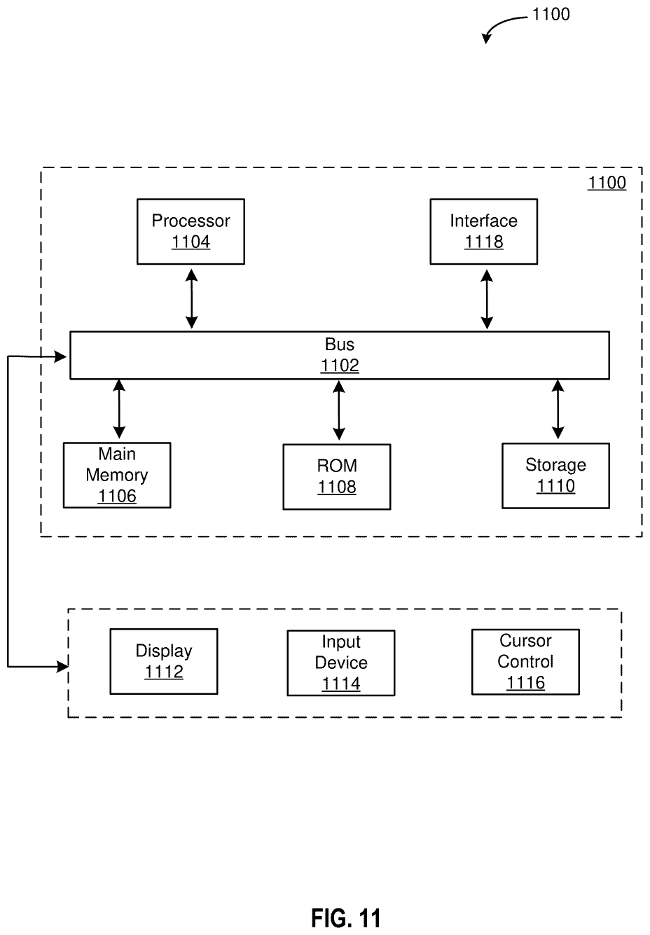

FIG. 11 depicts a block diagram of an example computer system 1100 in which various of the embodiments described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors.

Computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

Computer system 1100 may be coupled via bus 1102 to a display 1112, such as a liquid crystal display (LCD) (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. In some embodiments, the same direction information and command selections as cursor control may be implemented via receiving touches on a touch screen without a cursor.

Computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAS, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

Computer system 1100 also includes interface 1118 coupled to bus 1102. Interface 1118 provides a two-way data communication coupling to one or more network links that are connected to one or more local networks. For example, interface 1118 may be an integrated services digital network (ISDN) card, cable modem, satellite modem, or a modem to provide a data communication connection to a corresponding type of telephone line. As another example, interface 1118 may be a local area network (LAN) card to provide a data communication connection to a compatible LAN (or WAN component to communicated with a WAN). Wireless links may also be implemented. In any such implementation, interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 1118, which carry the digital data to and from computer system 1100, are example forms of transmission media.

The computer system 1100 can send messages and receive data, including program code, through the network(s), network link and interface 1118. In the Internet example, a server might transmit a requested code for an application program through the Internet, the ISP, the local network and interface 1118.

The received code may be executed by processor 1104 as it is received, and/or stored in storage device 1110, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1100.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A method comprising:
generating and storing location metadata of a software code file in an augmented software code data store, the location metadata being identified separately from contents of the software code file, and storage of the location metadata being augmented with the contents of the software code file that are stored in the augmented software code data store;
determining a revision history of the software code file associated with a user identifier of the software code file;
storing the user identifier and the revision history of the software code file in the augmented software code data store, the user identifier and the revision history being identified separately from the contents of the software code file, and storage of the user identifier and the revision history being augmented with the contents of the software code file that are stored in the augmented software code data store;
automatically generating a graph that comprises nodes identifying at least a portion of the software code file, the user identifier, and the revision history and edges of the graph that identify relationships between the software code file, the user identifier, and the revision history; and
using the graph, generating a response to a query associated with a software application that is executed based on the software code file.

2. The method of claim 1, further comprising:
receiving a ticketing system file that describes an error associated with the software application;
generating and storing error metadata of the ticketing system file in the augmented software code data store; and
automatically updating the graph with a node that identifies the ticketing system file and an edge of the graph that identifies a relationship between the ticketing system file, the error, and the nodes of the graph that identify at least the portion of the software code file, the user identifier, and the revision history.

3. The method of claim 1, wherein the graph comprises an edge that identifies a relationship between the software application and the software code file that is enabled to be compiled to generate the portion of the software application.

4. The method of claim 1, wherein the graph is a node graph that identifies information associated with the nodes of the graph.

5. The method of claim 1, wherein the graph is a relationship graph that identifies information as the edges to describe the relationships between the nodes of the graph.

6. The method of claim 1, wherein the software code file is enabled to be compiled to generate a portion of a software application, and wherein components of the software application are stored in distributed and separate software code data stores absent a central repository.

7. The method of claim 1, wherein a machine learning model is implemented to identify relationships between the nodes or the edges in the graph and augment the graph.

8. The method of claim 1, further comprising:
generating embeddings associated with the nodes in the graph that are semantically similar to the nodes; and
updating the graph with the embeddings.

9. A system comprising:
a memory; and
a processor that is configured to execute machine readable instructions stored in the memory for causing the processor to:
generate and store location metadata of a software code file in an augmented software code data store, the location metadata being identified separately from contents of the software code file, and storage of the location metadata being augmented with the contents of the software code file that are stored in the augmented software code data store;
determine a revision history of the software code file associated with a user identifier of the software code file;
store the user identifier and the revision history of the software code file in the augmented software code data store, the user identifier and the revision history being identified separately from the contents of the software code file, and storage of the user identifier and the revision history being augmented with the contents of the software code file that are stored in the augmented software code data store;
automatically generate a graph that comprises nodes identifying at least a portion of the software code file, the user identifier, and the revision history and edges of the graph that identify relationships between the software code file, the user identifier, and the revision history; and
using the graph, generate a response to a query associated with a software application that is executed based on the software code file.

10. The system of claim 9, wherein the processor is further to:
receive a ticketing system file that describes an error associated with the software application;
generate and store error metadata of the ticketing system file in the augmented software code data store; and
automatically update the graph with a node that identifies the ticketing system file and an edge of the graph that identifies a relationship between the ticketing system file, the error, and the nodes of the graph that identify at least the portion of the software code file, the user identifier, and the revision history.

11. The system of claim 9, wherein the graph comprises an edge that identifies a relationship between the software application and the software code file that is enabled to be compiled to generate the portion of the software application.

12. The system of claim 9, wherein the graph is a node graph that identifies information associated with the nodes of the graph.

13. The system of claim 9, wherein the graph is a relationship graph that identifies information as the edges to describe the relationships between the nodes of the graph.

14. The system of claim 9, wherein the software code file is enabled to be compiled to generate a portion of a software application, and wherein components of the software application are stored in distributed and separate software code data stores absent a central repository.

15. The system of claim 9, wherein a machine learning model is implemented to identify relationships between the nodes or the edges in the graph and augment the graph.

16. The system of claim 9, wherein the processor is further to:
generate embeddings associated with the nodes in the graph that are semantically similar to the nodes; and
update the graph with the embeddings.

17. A non-transitory computer-readable storage medium storing a plurality of instructions executable by a processor, the plurality of instructions when executed by the processor cause the processor to:
generate and store location metadata of a software code file in an augmented software code data store, the location metadata being identified separately from contents of the software code file, and storage of the location metadata being augmented with the contents of the software code file that are stored in the augmented software code data store;
determine a revision history of the software code file associated with a user identifier of the software code file;
store the user identifier and the revision history of the software code file in the augmented software code data store, the user identifier and the revision history being identified separately from the contents of the software code file, and storage of the user identifier and the revision history being augmented with the contents of the software code file that are stored in the augmented software code data store;
automatically generate a graph that comprises nodes identifying at least a portion of the software code file, the user identifier, and the revision history and edges of the graph that identify relationships between the software code file, the user identifier, and the revision history; and
using the graph, generate a response to a query associated with a software application that is executed based on the software code file.

18. The non-transitory computer-readable storage medium of claim 17, the plurality of instructions further causing the processor to:
receive a ticketing system file that describes an error associated with the software application;
generate and store error metadata of the ticketing system file in the augmented software code data store; and
automatically update the graph with a node that identifies the ticketing system file and an edge of the graph that identifies a relationship between the ticketing system file, the error, and the nodes of the graph that identify at least the portion of the software code file, the user identifier, and the revision history.

19. The non-transitory computer-readable storage medium of claim 17, wherein the graph comprises an edge that identifies a relationship between the software application and the software code file that is enabled to be compiled to generate the portion of the software application.

20. The non-transitory computer-readable storage medium of claim 17, wherein the graph is a node graph that identifies information associated with the nodes of the graph.
